(19) United States
(12) Patent Application Publication
(10) Pub. No.: US 2025/0063136 A1
(43) Pub. Date: Feb. 20, 2025

(54) GENERATIVE AI-BASED VIDEO ASPECT RATIO ENHANCEMENT

(71) Applicant: Samsung Electronics Co., Ltd., Suwon-si (KR)

(72) Inventors: Tomasz Jan Palczewski, Danville, CA (US); Anirudh Rao, San Jose, CA (US); Yingnan Zhu, Irvine, CA (US); Hong-Hoe Kim, Aliso Viejo, CA (US)

(21) Appl. No.: 18/409,531

(22) Filed: Jan. 10, 2024

Related U.S. Application Data
(60) Provisional application No. 63/533,564, filed on Aug. 18, 2023.

(51) Int. Cl. H04N 7/01; G06T 5/77; G06T 7/20

(52) U.S. Cl. CPC H04N 7/0122; G06T 5/77; G06T 7/20; G06T 2207/20084

(57) ABSTRACT

A method includes obtaining, using at least one processing device of an electronic device, a video including multiple scenes at a first aspect ratio. The method also includes performing, using the at least one processing device, backward optical flow estimation and forward optical flow estimation for each of the multiple scenes to select an image frame having a largest missing area. The method further includes performing, using the at least one processing device, outpainting on the image frame having the largest missing area to generate a first outpainted image frame at a second aspect ratio different from the first aspect ratio. In addition, the method includes performing, using the at least one processing device, backward optical flow estimation and forward optical flow estimation using the first outpainted image frame to generate additional outpainted image frames in the multiple scenes at the second aspect ratio.

### CROSS-REFERENCE TO RELATED APPLICATION AND PRIORITY CLAIM

This application claims priority under 35 U.S.C. § 119 (e) to U.S. Provisional Patent Application No. 63/533,564 filed on Aug. 18, 2023, which is hereby incorporated by reference in its entirety.

### TECHNICAL FIELD

This disclosure relates generally to machine learning systems and processes. More specifically, this disclosure relates to generative artificial intelligence (AI)-based video aspect ratio enhancement.

### BACKGROUND

Ultrawide displays are becoming increasingly popular among users, and future television products and other display products will also likely leverage wider displays. The majority of the devices used today to display images or videos support much lower aspect ratios, such as 4:3 and 16:9. The adoption of ultrawide displays may hamper viewing experiences of users because of the mismatch in content alignment. Gamers, content creators, streaming-app enthusiasts, and others want to leverage the entire real estate provided on display screens. Additionally, generating new content presents a challenge with temporal consistency. Delivering a seamless high-quality visual experience under changing conditions remains an open problem with ultrawide displays.

### SUMMARY

This disclosure relates to generative artificial intelligence (AI)-based video aspect ratio enhancement.

In a first embodiment, a method includes obtaining, using at least one processing device of an electronic device, a video including multiple scenes at a first aspect ratio. The method also includes performing, using the at least one processing device, backward optical flow estimation and forward optical flow estimation for each of the multiple scenes to select an image frame having a largest missing area. The method further includes performing, using the at least one processing device, outpainting on the image frame having the largest missing area to generate a first outpainted image frame at a second aspect ratio different from the first aspect ratio. In addition, the method includes performing, using the at least one processing device, backward optical flow estimation and forward optical flow estimation using the first outpainted image frame to generate additional outpainted image frames in the multiple scenes at the second aspect ratio.

In a second embodiment, an electronic device includes at least one processing device configured to obtain a video including multiple scenes at a first aspect ratio. The at least one processing device is also configured to perform backward optical flow estimation and forward optical flow estimation for each of the multiple scenes to select an image frame having a largest missing area. The at least one processing device is further configured to perform outpainting on the image frame having the largest missing area to generate a first outpainted image frame at a second aspect ratio different from the first aspect ratio. In addition, the at least one processing device is configured to perform backward optical flow estimation and forward optical flow estimation using the first outpainted image frame to generate additional outpainted image frames in the multiple scenes at the second aspect ratio.

In a third embodiment, a non-transitory machine-readable medium contains instructions that when executed cause at least one processor of an electronic device to obtain a video including multiple scenes at a first aspect ratio. The non-transitory machine-readable medium also contains instructions that when executed cause the at least one processor to perform backward optical flow estimation and forward optical flow estimation for each of the multiple scenes to select an image frame having a largest missing area. The non-transitory machine-readable medium further contains instructions that when executed cause the at least one processor to perform outpainting on the image frame having the largest missing area to generate a first outpainted image frame at a second aspect ratio different from the first aspect ratio. In addition, the non-transitory machine-readable medium contains instructions that when executed cause the at least one processor to perform backward optical flow estimation and forward optical flow estimation using the first outpainted image frame to generate additional outpainted image frames in the multiple scenes at the second aspect ratio.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit.” “receive.” and “communicate.” as well as derivatives thereof, encompass both direct and indirect communication. The terms “include” and “comprise.” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have.” “may have.” “include.” or “may include” a feature (like a number, function, operation, or component such as a part) indicate the existence of the feature and do not exclude the existence of other features. Also, as used here, the phrases “A or B.” “at least one of A and/or B.” or “one or more of A and/or B” may include all possible combinations of A and B. For example, “A or B.” “at least one of A and B.” and “at least one of A or B” may indicate all of (1) including at least one A. (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for.” “having the capacity to.” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A. B. and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a.” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC. APPLETV, or GOOGLE TV), a smart speaker or speaker with an integrated digital assistant (such as SAMSUNG GALAXY HOME. APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for generative AI-based video aspect ratio enhancement according to this disclosure:

FIG. 3 illustrates an example video frame having a first aspect ratio according to this disclosure:

FIG. 4 illustrates an example video frame having a desired aspect ratio according to this disclosure:

FIG. 5 illustrates an example outpainting operation in the process of FIG. 2 according to this disclosure:

FIG. 6 illustrates an example text prompt generated from a video frame according to this disclosure:

FIG. 7 illustrates a portion of an example chain-of-thought (COT) database according to this disclosure:

FIG. 8 illustrates an example optimized prompt that is generated from a text prompt using a large language model according to this disclosure;

FIG. 9 illustrates an example of an outpainted frame that can be generated from the frame of FIG. 4 according to this disclosure:

FIG. 10 illustrates another example outpainting operation in the process of FIG. 2 according to this disclosure; and

FIG. 11 illustrates an example method for generative AI-based video aspect ratio enhancement according to this disclosure.

### DETAILED DESCRIPTION

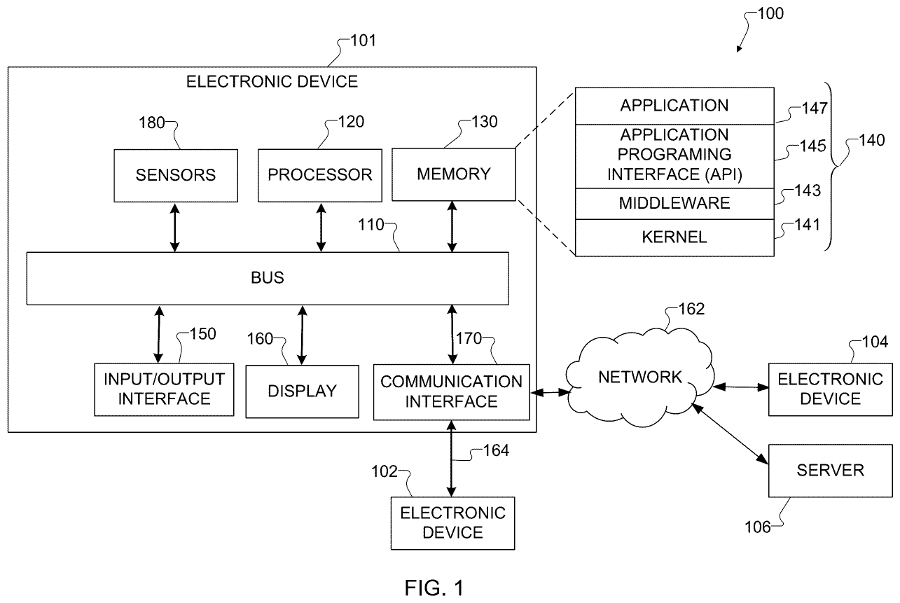

FIGS. 1 through 11, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, ultrawide displays are becoming increasingly popular among users, and future television products and other display products will also likely leverage wider displays. The majority of the devices used today to display images or videos support much lower aspect ratios, such as 4:3 and 16:9. The adoption of ultrawide displays may hamper viewing experiences of users because of the mismatch in content alignment. Gamers, content creators, streaming-app enthusiasts, and others want to leverage the entire real estate provided on display screens. Additionally, generating new content presents a challenge with temporal consistency. Delivering a seamless high-quality visual experience under changing conditions remains an open problem with ultrawide displays.

Recent advances in deep learning show that it is possible to address problems of super-resolution or quality correction via neural enhancement. For example, diffusion-based machine learning models have shown promise in generating high-quality images from text prompts. However, advances in video generation have not yet progressed particularly far. For instance, conventional techniques for video completion using generative AI technology are not production-ready.

One issue facing existing generative AI models is outpainting quality at the frame level (or image level). Generative adversarial network (GAN) models typically have problems with artifacts and are hard to train due to diminishing gradient and non-convergence problems. Such models are also highly sensitive to hyperparameter selection. This leads to problems when outpainting larger areas in a single inference step. Some other diffusion models (such as text-to-image or image-to-image models) show better quality results for outpainting tasks. However, these models also have some problems with artifacts and/or with content generation that does not align with the visual characteristic properties of the original content. In addition, for text-to-image diffusion models, it can be difficult to control shape and other visual aspects of the outpainting area.

Another issue facing existing generative AI models is temporal consistency (or temporal coherence). Each image frame can have a perfect outpainting. However, without an understanding of how the scene changes over time (and thus how pixels in outpainted areas should change based on timesteps), the resulting video may exhibit substantial flickering and inconsistencies. This is particularly true in scenes with fast moving objects, objects that exit frames, or static objects with changing brightness.

This disclosure provides various techniques for generative AI-based video aspect ratio enhancement. As described in more detail below, the disclosed embodiments feature a novel pipeline that leverages optical flow along with a generative diffusion model conditioned on prompts and video frames to achieve temporal and spatiotemporal coherence for generating content in any aspect ratio. The disclosed embodiments also provide video enhancement benefits, such as reduced flickering and artifacts. Note that while some of the embodiments discussed below are described in the context of use in consumer electronic devices (such as televisions and monitors), these are merely examples. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for generative AI-based video aspect ratio enhancement.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for generative AI-based video aspect ratio enhancement as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180) can include one or more cameras or other imaging sensors for capturing images of scenes. The sensor(s) 180) can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for generative AI-based video aspect ratio enhancement.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

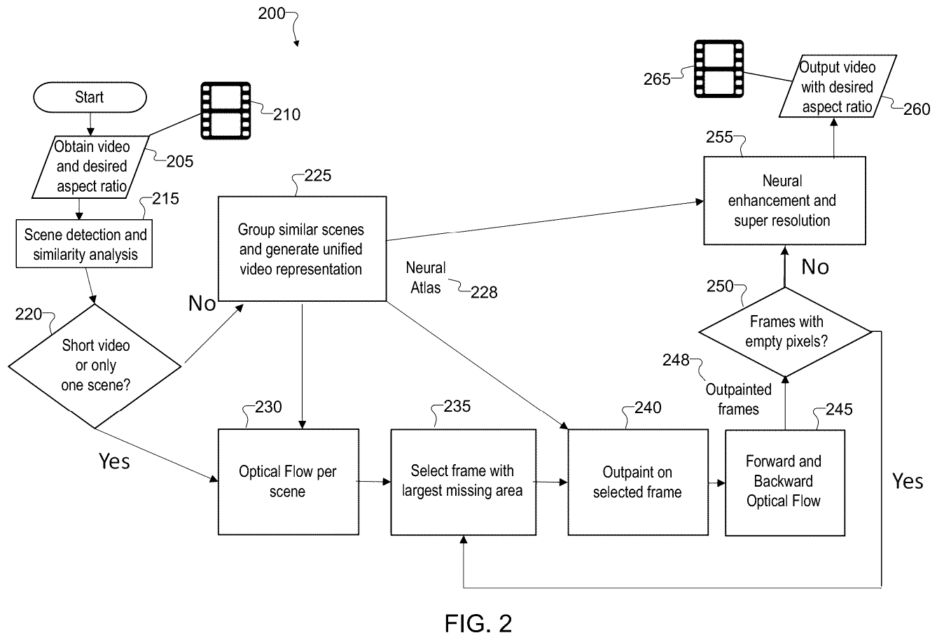

FIG. 2 illustrates an example process 200 for generative AI-based video aspect ratio enhancement according to this disclosure. For ease of explanation, the process 200 shown in FIG. 2 is described as being implemented using one or more components of the network configuration 100 of FIG. 1 described above, such as the electronic device 101. However, this is merely one example, and the process 200 could be implemented using any other suitable device(s) (such as the server 106) and in any other suitable system(s).

As shown in FIG. 2, the process 200 includes an operation 205 in which the electronic device 101 obtains a video 210 at a first aspect ratio. For example, the electronic device 101 can obtain the video 210 during a video capture operation. The capture operation may be performed in response to an event, such as a user actuating a video capture control of the electronic device 101. In some embodiments, the video 210 may be captured using one imaging sensor 180 of the electronic device 101, such as a camera having an RGB sensor. In other embodiments, the video 210 may be captured using multiple imaging sensors 180 of the electronic device 101. In still other embodiments, the video 210 may be retrieved from a memory or data storage or downloaded to the electronic device 101 from an external source.

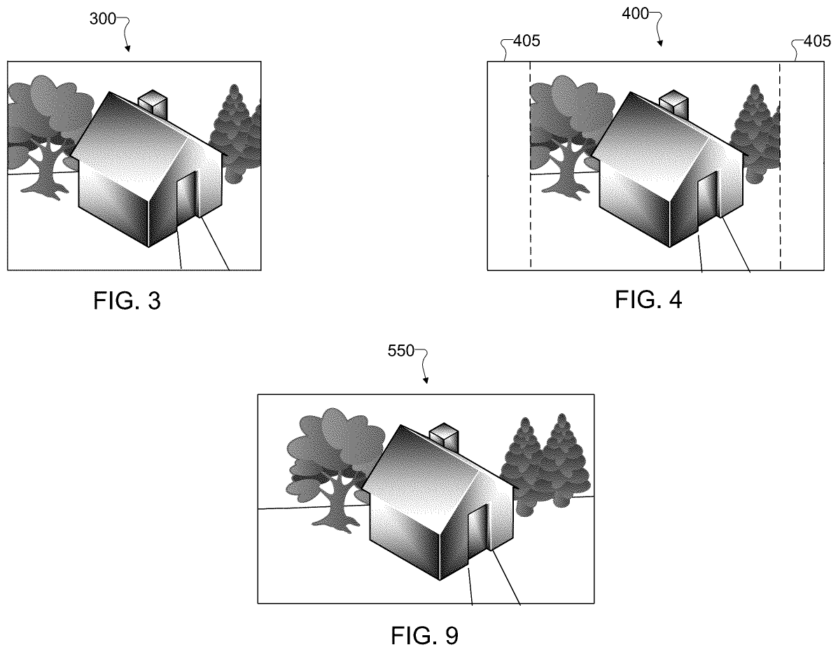

The video 210 includes multiple image frames at the first aspect ratio. FIG. 3 illustrates an example video frame 300 having a first aspect ratio according to this disclosure. As shown in FIG. 3, the frame 300 is an image of a scene (such as a house with trees in the background) at a 4:3 aspect ratio. The video 210 can include frames 300 capturing one scene or multiple scenes. In some embodiments, each frame 300 is a RGB image frame. In the operation 205, the electronic device 101 can also determine a desired aspect ratio to which to configure the video 210. The desired aspect ratio can be a wider aspect ratio than the first aspect ratio, such as a 16:9 or 32:9 aspect ratio.

At an operation 215, the electronic device 101 performs a scene detection and similarity analysis using the video 210. In this operation 215, the electronic device 101 detects the presence of each scene in the video 210 and determines similarities between the scenes. The operation 215 may involve the use of any suitable machine learning model or other logic to detect scenes and similarities between scenes. In some embodiments, the electronic device 101 employs a PyTorch deep learning model that is pre-trained to identify similarities between scenes. Also, in some embodiments, the electronic device 101 determines a uniqueness metric for each of the scenes and identifies scenes with uniqueness metrics that are substantially similar (such as within a specified similarity threshold). Of course, this is merely one example, and the electronic device 101 can use any suitable technique for detecting scenes and determining similarities between the scenes.

At an operation 220, based on the results of the operation 215, the electronic device 101 determines if the video 210 is a short video and/or a video with only one scene. If the electronic device 101 determines that the video 210 is not a short video and is not a video with only one scene, the electronic device 101 proceeds to an operation 225. Otherwise, if electronic device 101 determines that the video 210 is a short video and/or a video with only one scene, the electronic device 101 proceeds to an operation 230.

At the operation 225, the electronic device 101 groups similar scenes together using the similarity results from the operation 215. For example, if the video 210 includes three different scenes (which can be referred to as scene 1, scene 2, and scene 3) and scene 1 and scene 3 are determined to be similar, the electronic device 101 groups scene 1 and scene 3 together in order to map the group of scenes to a specific representation that can be used later in an outpainting model as described in greater detail below. Once the similar scenes are grouped together, the electronic device 101 creates at least one neural atlas 228 for each scene or group of similar scenes. A “neural atlas” refers to a unified video representation of a scene or a group of similar scenes. The electronic device 101 can use any suitable machine learning model or other logic to create neural atlases. In some cases, the electronic device 101 uses a deep learning extraction model that is trained to understand background and foreground elements of each scene (or group of similar scenes) with varying conditions and changes in camera angles and to generate the neural atlas 228 as an output. In some embodiments, the electronic device 101 generates a single neural atlas 228 for each scene or group of similar scenes. In other embodiments, the electronic device 101 generates multiple neural atlases 228 for each scene or group of similar scenes, such as one neural atlas 228 for the scene background and another neural atlas 228 for the scene foreground. In cases where the video 210 is a short video and/or a video containing only one scene, the electronic device 101 may generate a neural atlas 228 for the video 210 or may let the video 210 itself be the unified video representation in later processing.

At the operation 230, the electronic device 101 performs optical flow calculations per scene or group of scenes in the video 210 in order to estimate the motion of objects between the frames 300 in the video 210. For example, the electronic device 101 may perform both forward optical flow estimation and backward optical flow estimation on each scene or group of scenes. The electronic device 101 may use any suitable machine learning model or other logic for performing optical flow estimation, such as flow edge-guided video completion or vision transformer (ViT) techniques. One objective of the optical flow estimation in the operation 230 can be to start filling in pixels in the frames 300 of the video 210 based on the desired aspect ratio. FIG. 4 illustrates an example video frame 400 having a desired aspect ratio according to this disclosure. As shown in FIG. 4, the frame 400 is based on the frame 300 but has a desired aspect ratio of 16:9. The frame 400 initially includes expanded areas 405 on the left and right sides of the frame 400, which reflect the increased width of the frame 400 compared to the frame 300. The optical flow estimation in the operation 230 starts to fill in the expanded areas 405 with pixels based on the content found in the frame 300.

Once the electronic device 101 has performed optical flow calculations for each scene or group of scenes in the video 210, the electronic device 101 performs an operation 235 in which the electronic device 101 selects the frame 400 of the video 210 with the largest missing area (such as the frame with the largest number of empty pixels in the expanded areas 405). After selecting the frame 400, the electronic device 101 performs an outpainting operation 240 on the selected frame 400. The electronic device 101 may use any suitable machine learning model or other logic to perform outpainting. In some embodiments, when performing the outpainting operation 240, the electronic device 101 employs a combination of neural networks to fill in the remaining empty pixels in the selected frame 400.

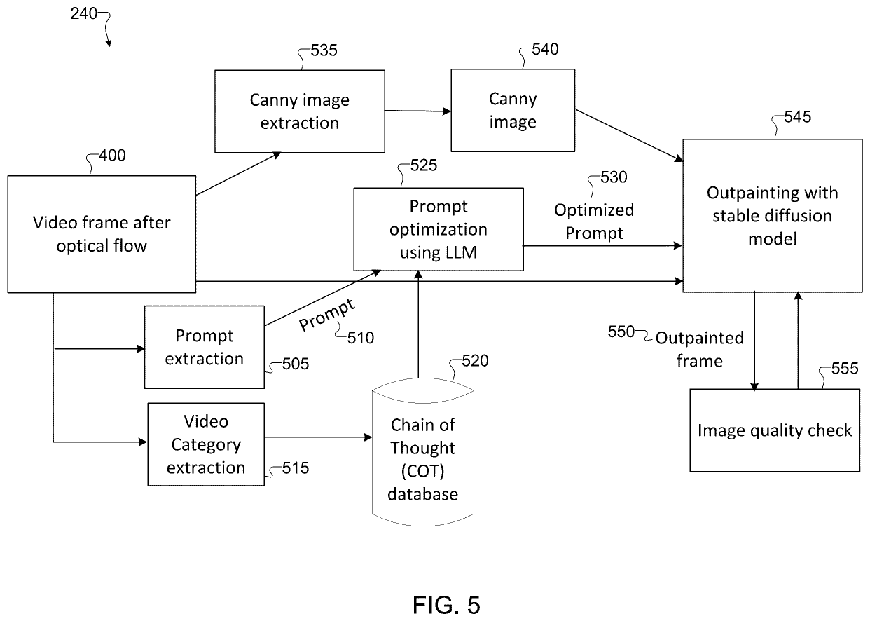

FIG. 5 illustrates an example outpainting operation 240 in the process 200 of FIG. 2 according to this disclosure. As shown in FIG. 5, the electronic device 101 performs the outpainting operation 240 on the selected frame 400, which is the frame of the video 210 with the largest missing area in the expanded areas 405. At an operation 505, the electronic device 101 performs prompt extraction on the frame 400, such as by using a prompt extraction model. As discussed in greater detail below, part of the outpainting operation 240 may use a text-to-image diffusion model, which uses a text prompt as an input. The electronic device 101 performs prompt extraction on the frame 400 to generate a prompt 510. The electronic device 101 may use any suitable machine learning model or other logic to perform prompt extraction. In some embodiments, the electronic device 101 implements a trained AI-based image-to-text model, such as CLIP Interrogator, to generate the prompt 510 based on the frame 400).

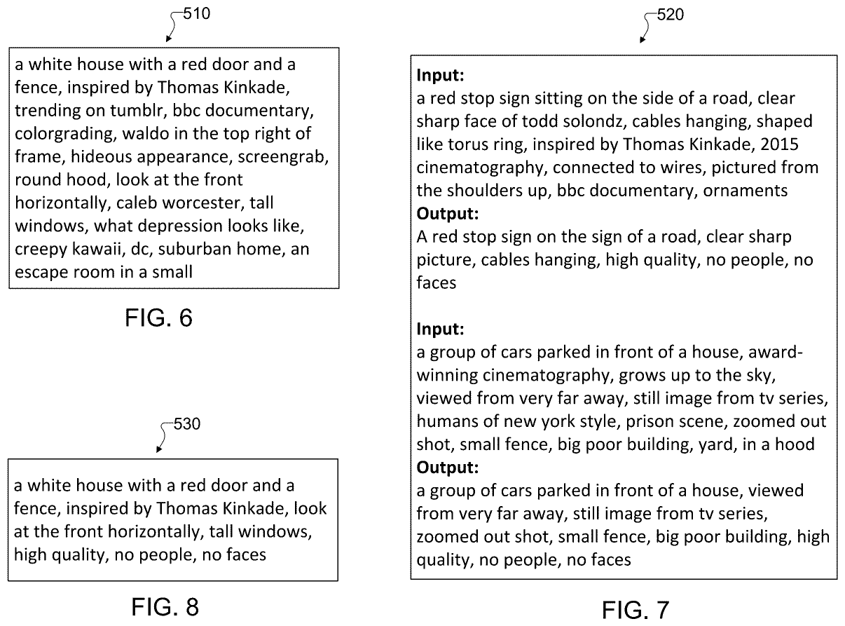

FIG. 6 illustrates an example text prompt 510) generated from a video frame 400 according to this disclosure. As shown in FIG. 6, the prompt 510 represents a text prompt that includes multiple descriptive words and phrases that attempt to describe the contents of the frame 400. Because some image-to-text models (such as CLIP Interrogator) can extract a significant amount of information, the resulting prompt 510 may include information that is not necessarily helpful for outpainting. For example, the example prompt 510 shown in FIG. 6 includes the phrase “waldo in the top right of frame.” However, the frame 400 does not actually include any element or figure that could represent “Waldo.” Thus, it can be helpful to optimize the prompt 510 before further outpainting.

The electronic device 101 also performs a video category extraction operation 515 on the frame 400. The video category extraction operation 515 examines the frame 400 to determine various types or categories associated with the frame 400. Each category identifies information about one or more genres and the subject matter of the frame 400. For example, the electronic device 101 may determine the following example categories after examination of the frame 400: “a detailed matte painting.” “inspired by Thomas Kinkade,” “American impressionism.” “trending on tumblr,” and “HGTV.” The electronic device 101 may use any suitable machine learning model or other logic for performing video category extraction. In some embodiments, the electronic device 101 uses a language-image pre-training framework, such as Bootstrapping Language-Image Pre-training (BLIP), to generate video categories using frames 400 as input. Of course, this is merely one example, and other suitable video category extraction techniques are possible and within the scope of this disclosure.

The electronic device 101 uses these categories as input to a chain-of-thought (CoT) database 520, which stores specific chain of thought prompts. FIG. 7 illustrates a portion of an example COT database 520 according to this disclosure. As shown in FIG. 7, the CoT database 520 includes pairs of inputs and outputs. During a lookup operation, the electronic device 101 correlates the categories from the video category extraction operation 515 to the inputs of the CoT database 520 to determine corresponding outputs from the CoT database, which are CoT prompts for the frame 400. The prompt 510 and the CoT prompts from the lookup are provided as inputs to a large language model (LLM).

At an operation 525, the electronic device 101 performs prompt optimization using the LLM, which optimizes (such as via rephrasing) the prompt 510 to an optimized prompt 530. The LLM leverages CoT techniques, which use the CoT prompts obtained from the CoT database 520 to generate the optimized prompt 530. FIG. 8 illustrates an example optimized prompt 530 that is generated from a text prompt using an LLM according to this disclosure. As shown in FIG. 8, the optimized prompt 530 is a simpler and more accurate prompt that contains less superfluous or inaccurate information about the frame 400 than the prompt 510.

The electronic device 101 also performs a canny image extraction operation 535 on the frame 400 in order to generate a canny image 540 that corresponds to the frame 400. The canny image 540 represents an extrapolation of edges in the frame 400 to unknown regions. The electronic device 101 may use any suitable machine learning model or other logic to perform canny image extraction. In some embodiments, during the canny image extraction operation 535, the electronic device 101 generates a greyscale image from the frame 400 and uses intensity values in the greyscale image to calculate one or more gradients of the image. The calculated gradients are used to determine which pixels belong to the edges in the frame 400, such as based on a threshold value. Pixels lying on the edges can be assigned a first value (such as 1), while other pixels can be assigned another value (such as 0). The result of the canny image extraction operation 535 is the canny image 540.

At an operation 545, the electronic device 101 performs outpainting on the frame 400, such as by using a stable diffusion model, to generate an outpainted frame 550. The stable diffusion model is a deep learning text-to-image model that is based on diffusion techniques. In some embodiments, the stable diffusion model includes ControlNet, which is a neural network architecture that adds spatial conditioning controls to large pretrained text-to-image diffusion models. In other embodiments, the stable diffusion model may not include ControlNet. The electronic device 101 provides the canny image 540, the frame 400, and the optimized prompt 530 as inputs to the stable diffusion model, which is trained to perform outpainting on a frame that includes missing pixel information. FIG. 9 illustrates an example of an outpainted frame 550 that can be generated from the frame 400 of FIG. 4 according to this disclosure. As shown in FIG. 9, the outpainted frame 550 has a desired aspect ratio of 16:9 and includes image information in the expanded areas 405, which were filled in using the stable diffusion model in the operation 545. The canny image 540 is provided to condition a unit of stable diffusion in the stable diffusion model. The electronic device 101 may use any suitable machine learning model or other logic to perform outpainting of a frame.

The electronic device 101 can perform an image quality check operation 555 on the outpainted frame 550 to ensure that the outpainted frame 550 exhibits a suitable image quality. The electronic device 101 may use any suitable machine learning model or other logic to check image quality. In some embodiments, the electronic device 101 employes a Vison Transformer (ViT) classifier, which uses a binary classification model to classify the outpainted frame 550 as a good quality image or a bad quality image. Of course, there is merely one example, and other image quality classifiers can be used, including other deep-learning models such as convolutional neural network (CNN)-based classifiers or even machine learning image classifiers (like a HAAR-cascade classifier). If the result of the image quality check operation 555 is that the outpainted frame 550 is not of a suitable quality, the electronic device 101 can adjust one or more inputs of the stable diffusion model and perform the outpainting operation 545 again.

Turning again to FIG. 2, once the electronic device 101 has generated a suitable outpainted frame 550 from the frame 400, the electronic device performs an operation 245 in which the electronic device 101 performs optical flow estimation again on the video 210. Here, the electronic device 101 can perform forward and backward optical flow estimation to outpaint other frames 400 into outpainted frames 248 based on the image pixel information in the outpainted frame 550).

Ideally, after operation 245, all outpainted frames 248 in the video 210 are complete with no missing information (such as empty pixels). However, in some cases, even after performing the operation 245, there may be one or more outpainted frames 248 that include missing information. Accordingly, at an operation 250, the electronic device 101 examines each of the outpainted frames 248 to determine if any of the outpainted frames 248 still includes expanded areas 405 with empty pixels. In such a case, the electronic device 101 returns to the operation 235 to select the outpainted frame 248 with the largest number of empty pixels and performs outpainting again.

At an operation 255, the electronic device 101 performs post-processing of the outpainted frames 248, such as neural enhancement and/or super-resolution on the outpainted frames 248 on a frame-by-frame basis. For example, the electronic device 101 may perform neural enhancement for deflickering (changing the brightness of static objects), artifact correction, any other suitable image correction, or a combination of these. The electronic device 101 can use any suitable machine learning model or other logic to provide neural enhancement. In some embodiments, the neural atlas 228 from the operation 225 is used as or in the neural enhancement model. At an operation 260, the electronic device 101 outputs an outpainted video 265 that includes the outpainted frames 248, which are in the desired aspect ratio.

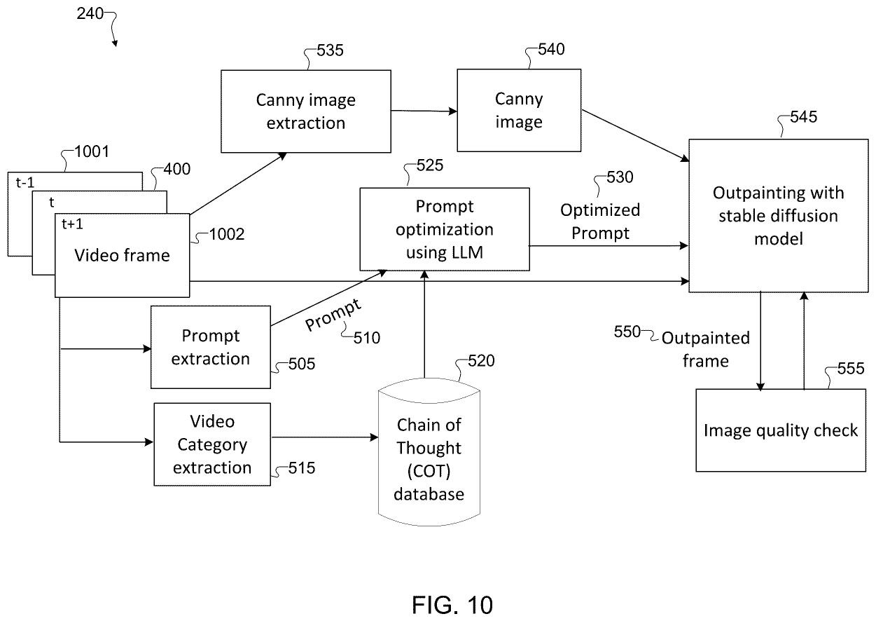

FIG. 10 illustrates another example outpainting operation 240) in the process 200 of FIG. 2 according to this disclosure. As shown in FIG. 10, this example of the outpainting operation 240 is similar to the outpainting operation 240 shown in FIG. 5. However, in FIG. 10, the conditioning of the stable diffusion model is expanded to include multiple frames 400 having other timestamps. For example, instead of using just the frame 400 with the largest missing area (where the frame 400 is at time t), the electronic device 101 also uses the previous frame 1001 (at time t−1) and the next frame 1002 (time t+1) to condition the stable diffusion model. This additional conditioning can provide a better result, although it may use a small amount of additional computational power and more time to process outpainting.

Although FIGS. 2 through 10 illustrate one example of a process 200 for generative AI-based video aspect ratio enhancement and related details, various changes may be made to FIGS. 2 through 10. For example, while the process 200 is described as involving specific sequences of operations, various operations described with respect to FIGS. 2 through 10 could overlap, occur in parallel, occur in a different order, or occur any number of times (including zero times). As a particular example, if the video 210 is a single scene video, the electronic device 101 may not need to perform operations 215, 220, and 225. Also, the specific operations shown in FIGS. 2 through 10 are examples only, and other techniques could be used to perform each of the operations shown in FIGS. 2 through 10. For instance, the optical flow calculations in operation 230 may not include edge extrapolation.

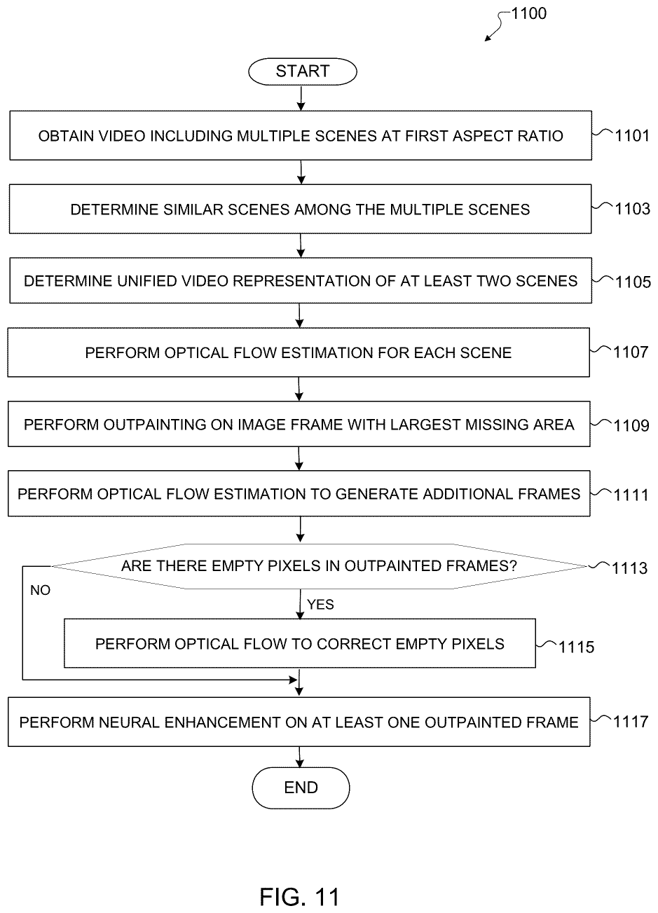

FIG. 11 illustrates an example method 1100 for generative AI-based video aspect ratio enhancement according to this disclosure. For ease of explanation, the method 1100 shown in FIG. 11 is described as being performed using the electronic device 101 and the process 200 shown in FIG. 2. However, the method 1100 shown in FIG. 11 could be used with any other suitable device(s) or system(s).

As shown in FIG. 11, at step 1101, a video that includes multiple scenes at a first aspect ratio is obtained. This could include, for example, the electronic device 101 obtaining the video 210, such as in the operation 205. At step 1103, similar scenes are determined among the multiple scenes. This could include, for example, the electronic device 101 determining a uniqueness metric for each of the multiple scenes of the video 210 and identifying at least two scenes having uniqueness metrics within a similarity threshold, such as in the operation 215. At step 1105, a unified video representation of at least two scenes of the multiple scenes is determined, such as by using a neural network. This could include, for example, the electronic device 101 generating at least one neural atlas 228, such as in the operation 225, and the unified video representation can include the at least one neural atlas 228.

At step 1107, backward and forward optical flow estimations are performed for each of the multiple scenes to select an image frame having a largest missing area. This could include, for example, the electronic device 101 performing optical flow and selecting the frame 400 with the largest missing area, such as in operations 230) and 235. At step 1109, outpainting is performed on the image frame having the largest missing area to generate a first outpainted image frame at a second aspect ratio different from the first aspect ratio. This could include, for example, the electronic device 101 outpainting the frame 400 to generate the outpainted frame 550, such as in the operation 240 and FIG. 5. At step 1111, backward and forward optical flow estimations are performed using the first outpainted image frame to generate additional outpainted image frames in the multiple scenes at the second aspect ratio. This could include, for example, the electronic device 101 generating additional outpainted frames 248, such as in the operation 245.

At step 1113, it is determined whether there are empty pixels in the outpainted image frames. This could include, for example, the electronic device 101 determining if there are frames with empty pixels, such as in the operation 250. At step 1115, in response to determining that there are one or more empty pixels in at least one of the outpainted image frames, backward optical flow estimation and forward optical flow estimation are performed again using one of the outpainted image frames to correct the one or more empty pixels. This could include, for example, the electronic device 101 returning to the operation 235 to select the outpainted frame 248 with the largest number of empty pixels, and then performing outpainting again. At step 1117, neural enhancement is performed on at least one of the outpainted image frames using a neural enhancement model. This could include, for example, the electronic device 101 performing deflickering and artifact correction on at least one of the outpainted frames 248, such as in the operation 255.

Although FIG. 11 illustrates one example of a method 1100 for generative AI-based video aspect ratio enhancement, various changes may be made to FIG. 11. For example, while shown as a series of steps, various steps in FIG. 11 could overlap, occur in parallel, occur in a different order, or occur any number of times (including zero times).

Note that the operations and functions shown in or described with respect to FIGS. 2 through 11 can be implemented in an electronic device 101, 102, 104, server 106, or other device(s) in any suitable manner. For example, in some embodiments, the operations and functions shown in or described with respect to FIGS. 2 through 11 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 11 can be implemented or supported using dedicated hardware components. In general, the operations and functions shown in or described with respect to FIGS. 2 through 11 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, a video including multiple scenes at a first aspect ratio;
performing, using the at least one processing device, backward optical flow estimation and forward optical flow estimation for each of the multiple scenes to select an image frame having a largest missing area;
performing, using the at least one processing device, outpainting on the image frame having the largest missing area to generate a first outpainted image frame at a second aspect ratio different from the first aspect ratio; and
performing, using the at least one processing device, backward optical flow estimation and forward optical flow estimation using the first outpainted image frame to generate additional outpainted image frames in the multiple scenes at the second aspect ratio.

2. The method of claim 1, further comprising:
determining whether there are empty pixels in the outpainted image frames; and
in response to determining that there are one or more empty pixels in at least one of the outpainted image frames, performing backward optical flow estimation and forward optical flow estimation using one of the outpainted image frames again to correct the one or more empty pixels.

3. The method of claim 1, further comprising:
determining a unified video representation of at least two scenes of the multiple scenes using a neural network, the unified video representation including at least one neural atlas.

4. The method of claim 1, further comprising:
performing deflickering and artifact correction on at least one of the outpainted image frames using a neural enhancement model.

5. The method of claim 1, wherein performing outpainting on the image frame having the largest missing area comprises:
extracting a text prompt from the image frame having the largest missing area using an image-to-text model;
optimizing the text prompt using a large language model; and
outpainting the image frame having the largest missing area using a text-to-image diffusion model and the optimized text prompt.

6. The method of claim 5, wherein the image-to-text model comprises a prompt extraction model and a language-image pre-training framework.

7. The method of claim 1, further comprising:
determining a uniqueness metric for each of the multiple scenes; and
identifying at least two scenes of the multiple scenes having uniqueness metrics within a similarity threshold.

8. An electronic device comprising:
at least one processing device configured to:
obtain a video including multiple scenes at a first aspect ratio;
perform backward optical flow estimation and forward optical flow estimation for each of the multiple scenes to select an image frame having a largest missing area;
perform outpainting on the image frame having the largest missing area to generate a first outpainted image frame at a second aspect ratio different from the first aspect ratio; and
perform backward optical flow estimation and forward optical flow estimation using the first outpainted image frame to generate additional outpainted image frames in the multiple scenes at the second aspect ratio.

9. The electronic device of claim 8, wherein the at least one processing device is further configured to:
determine whether there are empty pixels in the outpainted image frames; and
in response to determining that there are one or more empty pixels in at least one of the outpainted image frames, perform backward optical flow estimation and forward optical flow estimation using one of the outpainted image frames again to correct the one or more empty pixels.

10. The electronic device of claim 8, wherein the at least one processing device is further configured to determine a unified video representation of at least two scenes of the multiple scenes using a neural network, the unified video representation including at least one neural atlas.

11. The electronic device of claim 8, wherein the at least one processing device is further configured to perform deflickering and artifact correction on at least one of the outpainted image frames using a neural enhancement model.

12. The electronic device of claim 8, wherein, to perform outpainting on the image frame having the largest missing area, the at least one processing device is configured to:
extract a text prompt from the image frame having the largest missing area using an image-to-text model;
optimize the text prompt using a large language model; and
outpaint the image frame having the largest missing area using a text-to-image diffusion model and the optimized text prompt.

13. The electronic device of claim 12, wherein the image-to-text model comprises a prompt extraction model and a language-image pre-training framework.

14. The electronic device of claim 8, wherein the at least one processing device is further configured to:
determine a uniqueness metric for each of the multiple scenes; and
identify at least two scenes of the multiple scenes having uniqueness metrics within a similarity threshold.

15. A non-transitory machine-readable medium containing instructions that when executed cause at least one processor of an electronic device to:
obtain a video including multiple scenes at a first aspect ratio;
perform backward optical flow estimation and forward optical flow estimation for each of the multiple scenes to select an image frame having a largest missing area;
perform outpainting on the image frame having the largest missing area to generate a first outpainted image frame at a second aspect ratio different from the first aspect ratio; and
perform backward optical flow estimation and forward optical flow estimation using the first outpainted image frame to generate additional outpainted image frames in the multiple scenes at the second aspect ratio.

16. The non-transitory machine-readable medium of claim 15, further containing instructions that when executed cause the at least one processor to:
determine whether there are empty pixels in the outpainted image frames; and
in response to determining that there are one or more empty pixels in at least one of the outpainted image frames, perform backward optical flow estimation and forward optical flow estimation using one of the outpainted image frames again to correct the one or more empty pixels.

17. The non-transitory machine-readable medium of claim 15, further containing instructions that when executed cause the at least one processor to determine a unified video representation of at least two scenes of the multiple scenes using a neural network, the unified video representation including at least one neural atlas.

18. The non-transitory machine-readable medium of claim 15, further containing instructions that when executed cause the at least one processor to perform deflickering and artifact correction on at least one of the outpainted image frames using a neural enhancement model.

19. The non-transitory machine-readable medium of claim 15, wherein the instructions that when executed cause the at least one processor to perform outpainting on the image frame having the largest missing area comprise:
instructions that when executed cause the at least one processor to:
extract a text prompt from the image frame having the largest missing area using an image-to-text model;
optimize the text prompt using a large language model; and
outpaint the image frame having the largest missing area using a text-to-image diffusion model and the optimized text prompt.

20. The non-transitory machine-readable medium of claim 19, wherein the image-to-text model comprises a prompt extraction model and a language-image pre-training framework.
